(19) United States
(12) Patent Application Publication
(10) Pub. No.: US 2006/0168875 A1
(43) Pub. Date: Aug. 3, 2006

(54) Sliding c-weight

(76) Inventor: Frank T. Brzozowski, Philadelphia, PA (US)

Correspondence Address: FRANK T. BRZOZOWSKI, 2357 E. Dauphin Street, Philadelphia, PA, 19125, US

(21) Appl. No.: 11/372,620

(22) Filed: Mar. 10, 2006

Related U.S. Application Data
(63) Continuation-in-part of application No. 10/724,859, filed on Nov. 30, 2003.

(51) Int. Cl. A01K 95/00

(52) U.S. Cl. 43/44.9; 43/42.39; 43/43.15; 43/44.87

(57) ABSTRACT

A c-weight 25 is a fishing sinker shaped like a “C.” The sliding c-weight is unique by having two attributes that most other fishing sinkers do not possess, it slides freely and it could be fixed at a specific location on the fishing line. The c-weight 25 has three main sections, a first end 28, a c-weight hull 26, and a second end 34. The c-weight 25 has a first end 28 with a first bore there through 30. The c-weight 25 has a c-weight hull 26 in the central and lower middle section with an optional longitudinal groove 40 that connects with the first end 28 and the second end 34. The c-weight 25 has a second end 34 with a second bore there through 36. The removable sliding c-weight 25 has a first slot 32 connected to a first bore 30. The c-weight 25 has a second slot 38 as shown in FIG. 2 connected to a second bore 36. The c-weight 25 has an optimal longitudinal groove 40 therein for allowing the c-weight to be fixedly connected to the leader 13.

CROSS REFERENCE TO RELATED APPLICATIONS
U.S. Patent Documents

| Country-Number | MM-YYYY | Name Classification |
|---|---|---|
| US-6,325,136 | December 2001 | Ratte, Geoffrey S. 164/129, 164/131 |
| US-6,305,121 | November 2000 | Adams, Nicholas S. 43/44.96, 43/43.1 |
| US-6,170,191 | January 2001 | Laney, Scot H. 43/43.13 43/44.9 |
| US-6,145,240 | June 1999 | Adams, Nicholas S. 43/44.96 |
| US-6,076,297 | June 2000 | Lippincott, Robert 43/44.87, 43/44.91 |
| US-6,073,386 | June 2000 | Firmin, Herman P. 43/44.87, 43/44.9 |
| US-6,047,493 | April 2000 | Strampe, Clarence W. 43/44.96, 43/44.97 43/44.87 |
| US-5,918,408 | July 1999 | Laney, Scot H. 43/43.13 43/44.9 |
| US-5,887,381 | March 1999 | Stephenson, Timothy L. 43/43.15 |
| US-5,878,525 | March 1999 | Metzler, Norman P. 43/43.1, 43/44.94 |
| US-5,678,351 | October 1997 | Halterman, Jr., Danny R. 43/43.1 |
| US-5,673,508 | October 1997 | Snyder, Gary 43/42.37, 43/44.8, 43/44.82 |
| US-4,696,125 | September 1987 | Rayburn, Walter 43/43.14 |
| US-4,209,933 | July 1980 | Manno, Joseph T. 43/43.15 |
| US-3,701,212 | October 1972 | Gilliam, Joe L. 43/44.87 |
| US-3,118,245 | January 1964 | Shriver, Lloyd L. 43/43.15 |
| US-3,096,599 | July 1963 | Baron, Charles 43/44.9 |
| US-2,766.549 | October 1956 | Dickerson, William 43/44.98 |
| US-2,703,947 | March 1955 | Petrasek et. al. 43/42.39 |
| US-2,177,007 | October 1939 | Smith, Wallace E. 43/44.88 |
| US-2,019,630 | November 1935 | Peeso, Martin E. 43/43.11 |
| US-1,883,574 | October 1932 | Cleeland, John S. 43/43.1 |
| US-1,208,936 | December 1916 | England, Henry 43/43.1 |
| US-10/724,859 | March 2006 | Brzozowski, Frank T. 43/43.15 |
| D458,982 S | June 2002 | Ratte, Geoffrey S. D22/145 |

Foreign Patent Documents

| Country-Number | MM-YYYY | Name |
|---|---|---|
| PCT/US2003/038034 | November 2003 | Brzozowski |
| Canada No. US2003038034 | May 2005 | Brzozowski |
| Australia No. 2003298750 | June 2005 | Brzozowski |
| New Zealand No. 5450975 | June 2005 | Brzozowski |
| EPO No. 03796508.4-2321 | June 2005 | Brzozowski |

Publications

| | |
|---|---|
| PCT Publication No.: | WO 2004/049788 A3 |
| US Publication No.: | US 2004/0107629 A1 Jun. 10, 2004 |

Other References

Pfeiffer, C. Boyd. “The Field and Stream Baits and Rigs Handbook,”
ISBN 1-55821-883-1, The Lyons Press 1999.
Bass Pro Outdoors Online LLC, www.basspro.com

### PARENT CASE TEXT AND RELATED APPLICATIONS

This application, the “Sliding C-weight,” is also related to a continuation-in-part patent application filed concurrently with the present application under the title of “Horizontal Unilateral Fish Hook” and this application is a continuation-in-part of U.S. patent application Ser. No. 10/724,859 filed on Nov. 30, 2003. The disclosure of the above application is incorporated herein by reference. This application is also based on provisional application No. 60/430,325, filed on Nov. 30, 2002 which incorporated the Document Disclosure Deposit Request No. 504577 filed on Jan. 28, 2002.

### BACKGROUND OF THE INVENTION

1. Field of the Invention

The present invention, the sliding c-weight, has particular utility in connection with fishing tackle by having a fishing weight that fishing line is inserted through two ends with bores and the sliding c-weight could be utilized to serve different functions.

2. Description of the Prior Art

The bottom fish rig which is the parent patent has a c-weight as a component of the invention. The c-weight is a fishing sinker shaped like a “C”. The sliding c-weight could be used independently on a fishing line like a sinker or made as a component of a fishing rig. The sliding c-weight is unique by having attributes that most other fishing sinkers do not possess. The “C” shaped sinker and the bores on both ends causes the weight to slide freely down a fishing line, or with a wrap of the fishing line or leader around its central hull, to become a stationary fishing sinker that is more versatile and easier to use that other fishing weights. One embodiment is a solid weight made of various metals or alloys, including but not limited to iron, tin, zinc, or silicone compounds. Another embodiment has a hollow hull that materials could be inserted to give the c-weight special effects.

An investigation of bait stores, sporting goods stores, internet catalogues and fishing books did not find or reveal a sliding c-weight. A sliding c-weight is new, unique and performs differently from the usual fishing tackle that is used to lower fishing line to the bottom: walking sinkers, lead bait-walker sinkers, bank sinkers, dollar sinkers, disc sinkers, pyramid weights, triangular weights, one-eyed sinkers, cannonball sinkers, mushroom sinkers, grapnel sinkers, and snap-lock sinker are usually secured to the fishing line by tying with a square knots or other specialized knots. The sliding c-weight is unlike other fishing weights that are crimped to the fishing lines such as split shots, rubber-grip sinkers, dipsy sinker, and clasp, clinch or pinch-on sinkers.

Another embodiment, the removable sliding c-weight has an appearance and features different from other fishing tackle, such as worm slip sinkers, sliding bullet sinkers, egg-sinkers, longhorn sinkers, pencil sinkers, and elongated salt-water lead sinkers with two bronze eyelets on the opposite ends, keel trolling sinkers, crescent-shaped trolling sinkers, bead chain trolling sinkers, torpedo sinkers, molded-on lead sinkers, diving sinkers, and the like. These commercial weights are usually attached to a fishing line by passing the line through an opening, as in the egg sinkers, while other sinkers are usually intended to be stationary by tying specialized knots after the fishing line is wrapped around the eyelet. To remove these weights a fisherman usually has to cut the line. Other lighter weights such as split shots have to be crimped with a tool, such as pliers, to be effective stationary weights. In the prior art none of the patents displayed or illustrated an embodiment like the sliding c-weight.

A removable fishing sinker by Baron, U.S. Pat. No. 3,096,599 has a body made of heavy metal with a sleeve made of a light plastic material in which fishing line is inserted and jammed between a sleeve and sinker body into a long central slot. Although the egg-shaped removable fishing sinker could slide freely over the fishing line or could be mounted fixed on a fishing line, Baron's sinker has at least 3 individual components, in contrast to the one piece removable c-weight, excluding the hull plug of one embodiment. The removable c-weight is more durable, costs less and is easier to produce than the removable fishing sinker.

Lippincott also used an elastmor insert within an environmentally safe weighing attachment for a fishing line to obtain U.S. Pat. No. 6,076,297. It has multiple components and is unlike the one piece removable c-weight, excluding the hull plug of one embodiment.

The saltwater sinker by Gilliam, U.S. Pat. No. 3,701,212 has the shape of an egg sinker but it is designed to stay stationary upon the fishing line by wrapping the leader or line around a crotch and by crimping its locking arms. In contrast to the present invention, the one piece removable c-weight attaches quickly, is more durable, costs less and is easier to produce than Gilliam's sinker.

The fishing rig and sinker by Firmin, U.S. Pat. No. 6,073,386, resembles two cones abutting at the wide ends with a narrow connecting waist. Firmin's patent has a hollow double barreled sinker through which fishing line is threaded. Although Firmin's sinker could be moved along the fishing line without untying knots, the sinker becomes permanently attached to the fishing line and it does not have the capability to be easily attached and removed as the removable sliding c-weight.

U.S. Pat. No. 2,177,007 to Smith discloses a complicated releasable sinker having weigh changing means. In Smith's patent the sinker is released to slide down the line and encounter the lure. Smith has a cylindrical bore slip sinker or egg sinker held into a carrier tube by a frictional locking device that fits into a slot in the wall of the egg sinker. Smith's patent has the egg sinker that is different from the sliding c-weight.

U.S. Pat. No. 1,883,574 to Cleeland discloses a sinker that attaches to fishing line without parting the line. Cleeland's lead sinker has a streamline body with wire coils on each end and a frictional groove spiral around the body; Cleeland's patent does not have a central bore and does not slide. Cleeland's patent does not look like, or function like, the sliding c-weight.

Yet further another slip sinker patent that at first seems similar, but operated differently is, U.S. Pat. No. 5,878,525 to Metzler which discloses a removable fishing weight. However, in Metzler's patent the fishing line has to be inserted through nylon or plastic tube before the weight is attached and it is essential to make the sinker removable. In contrast to this invention, the sliding c-weight is basically one piece that is easier to apply in the field and to manufacture.

Yet further, U.S. Pat. No. 5,673,508 to Snyder discloses a beaded fishing lure having a weighted body molded to a fish hook that includes a beaded trailer hook. A flapper piece oscillates with lure movement about a projecting extension of the hook shank to strike the body and produce audible sound. The flapper is secured to the body with a split ring at aligned apertures and from a slot which mounts about the hook extension. The eye of the trailer hook is secured to the shank of the primary hook and a bead is molded to the trailer hook. A variety of dressings mount to the bead including multi-filament skirts and molded plastic tails. However, the Snyder '508 patent does not have the ability to be easily attached and removed as the removable sliding c-weight.

Patents have been issued for different types of sinkers that do not resemble the sliding c-weight. U.S. Pat. Nos. 6,170,191 and 5,918,408 went to Laney for the diving fishing weight which has fins and functions differently than the sliding c-weight. U.S. Pat. Nos. 6,325,136 and D458,982 S, were issued to Ratte who made a fishing sinker and its mold for a bismuth and bismuth alloy fishing sinker. These sinkers resemble large split shots and clamp onto the fishing line and functions differently than the sliding c-weight. Strampe made a tip and slip bottom bouncer, U.S. Pat. No. 6,047,493, that looks like a large wire U-loop with a weight and the entire apparatus is attached to a fishing line. In contrast to this invention, the sliding c-weight is basically one piece that is more compact, simple to apply in the field and to manufacture.

Lastly, U.S. Pat. Nos. 6,305,121 and 6,145,240 to Adams discloses a fishing sinker having a body with a buoyant portion having a density less than water and a weighted potion with a density greater than water. Adams' fishing sinker has a body formed or molded around an elongated wire. Although it has a central wire with loops at opposite ends the sinker does not have the ability to be easily attached and removed as the removable sliding c-weight.

While the above-described devices fulfill their respective, particular objectives and requirements, the aforementioned patents do not describe an invention that functions and is shaped like the sliding c-weight, which is basically a one piece sinker that is more compact, simple to apply in the field, and to manufacture. Beside the prior art and aforementioned patents, the present invention has components that are nonobvious, novel, useful, and an improvement over other inventions in the field. A removable sliding weight is novel by itself individually and when used as a component in the parent invention, the bottom fish rig.

### SUMMARY OF THE INVENTION

A c-weight 25 is a fishing sinker shaped like a “C. The sliding c-weight is unique by having two attributes that most other fishing sinkers do not possess, it slides freely and it could be fixed at a specific location on the fishing line. The c-weight 25 has three main sections, a first end 28, a c-weight hull 26, and a second end 34. The c-weight 25 has a first end 28 with a first bore there through 30. The c-weight 25 has a c-weight hull 26 in the central and lower middle section with an optional longitudinal groove 40 that connects with the first end 28 and the second end 34. The c-weight 25 has a second end 34 with a second bore there through 36.

A preferred embodiment is a removable sliding c-weight. The removable c-weight 25 has a first slot 32 connected to a first bore 30. The c-weight 25 has a second slot 38 as shown in FIG. 2 connected to a second bore 36. Fishing line is easily inserted into slots, 32 and 38, of the first end 28 and of the second end 34. The c-weight 25 has an optimal longitudinal groove 40 therein for allowing the c-weight to be fixedly connected to the leader 13. Another embodiment is a solid weight made of various metals or alloys, including but not limited to iron, tin, zinc, or silicone compounds. Another embodiment has a hollow hull 26 with a c-weight hole 27 and plug 39 that materials could be inserted within to give the c-weight special effects; and a hollow hull could be made with perforations to create more openings. Both embodiments, solid or with a hollow hull, could be made as a sliding c-weight or a removable sliding c-weight.

In view of the foregoing disadvantages inherent in the known types of fishing tackle now present in the prior art, the present embodiment of the invention provides an improved sliding c-weight, and overcomes the above-mentioned disadvantages and drawbacks of the prior art. As such, the general purpose of the present embodiment of the invention, which will be described subsequently in greater detail, is to provide a new and improved bottom fish rig and method which has all the advantages of the prior art mentioned heretofore and many novel features that result in a sliding c-weight which is not anticipated, rendered obvious, suggested, or even implied by the prior art, either alone or in any combination thereof.

The prior art of record neither discloses nor fairly teaches the recited limitations of the claimed combination including, but not limited to a c-weight, individually, or as a component of the parent patent, the bottom fish rig.

There has thus been outlined, rather broadly, the more important features of the embodiment of the invention in order that the detailed description thereof that follows may be better understood and in order that the present contribution to the art may be better appreciated. There are, of course, additional features of the present embodiment of the invention that will be described hereinafter and which will form the subject matter of the claims attached.

Numerous objects, features and advantages of the present embodiment of the invention will be readily apparent to those of ordinary skill in the art upon a reading of the following detailed description of presently preferred, but nonetheless illustrative, embodiments of the present embodiment of the invention when taken in conjunction with the accompanying drawings. In this respect, before explaining the current embodiment of the embodiment of the invention in detail, it is to be understood that the embodiment of the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of descriptions and should not be regarded as limiting.

As such, those skilled in the art will appreciate, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present embodiment of the invention.

Objects and Advantages

It is therefore an object of the present embodiment of the invention to provide a new and improved sliding c-weight that has all of the advantages of the prior art fishing tackle and none of the disadvantages.

It is another object of the present embodiment of the invention to provide a new and improved sliding c-weight that may be easily and efficiently manufactured and marketed.

An even further object of the present embodiment of the invention is to provide a new and improved sliding c-weight that has a low cost of manufacture with regard to both materials and labor, and which accordingly is then susceptible of low prices of sale to the consuming public, thereby making such sliding c-weight economically available to the buying public.

Still another object of the present embodiment of the invention is to provide a new sliding c-weight that provides in the apparatuses and methods of the prior art some of the advantages thereof, while simultaneously overcoming some of the disadvantages normally associated therewith.

Another object of the present embodiment of the sliding c-weight is its novel features, consisting of attributes that most other fishing sinkers do not possess, it slides freely or it could be fixed at a specific location on the fishing line.

Yet another object of the sliding c-weight could be used independently on a fishing line like a sinker or made as a component of a fishing rig.

An object of the present invention is to provide a useful and unique sinker with two ends that are arched or angled to cause the sliding c-weight to slide like a sled while being used.

Another object of the removable sliding c-weight in this invention is to be easily installed without any tool, and is removed from the fishing line quicker than the common fishing tackle sinkers without cutting the fishing line or the leader to which it is attached.

Another object of the present invention is to create a solid weight made of various metals or alloys, including but not limited to iron, tin, zinc, or silicone compounds.

Even still another object of the present embodiment of the invention is to provide a sliding c-weight for fishing tackle having various removable sliding weights made of different products having various sizes, shapes and styles.

Another object of the present invention is to construct a hollow removable sliding c-weight that could have many different objects and substances inserted into its hollow hull to affect the rate of descent and to attract fish to the fishing line.

Lastly, both embodiments, solid or with a hollow hull, could be made as a sliding c-weight or a removable sliding c-weight which is still another object of the present embodiment of the invention.

These together with other objects of the embodiment of the invention, along with the various features of novelty that characterize the embodiment of the invention, are pointed out with particularity in the claims annexed to and forming a part of this disclosure. For a better understanding of the embodiment of the invention, its operating advantages and the specific objects attained by its uses, reference should be made to the accompanying drawings and descriptive matter in which there are illustrations of the preferred embodiments of the invention.

### BRIEF DESCRIPTION OF THE DRAWINGS

The embodiment of the invention will be better understood and objects other than those set forth above will become apparent when consideration is given to the following detailed description thereof. Such description makes reference to the annexed drawings wherein:

FIG. 1 is a top perspective view of the preferred embodiment of a bottom fish rig constructed in accordance with the principles of the present invention, a sliding c-weight.

FIG. 2 is a front view of a second end of a removable sliding c-weight of the present embodiment of the invention.

FIG. 3 is a side view of a left side of a removable sliding c-weight of the present embodiment of the invention.

FIG. 4 is a front view of a first end of a removable sliding c-weight of the present embodiment of the invention.

FIG. 5 is a top left side perspective view of a second embodiment of a removable sliding c-weight of the invention.

FIG. 6 is a left side view of a second embodiment of a removable sliding c-weight of the bottom fish rig of the invention.

FIG. 7 is a top view of the second embodiment of a removable sliding c-weight of the bottom fish rig of the invention.

FIG. 8 is a front end view of the second embodiment of the c-weight of the bottom fish rig of the present embodiment of the invention.

FIG. 9 is a side perspective view of the third embodiment of sliding c-weight of the invention.

FIG. 10 is a cross-sectional side view of a fourth embodiment of sliding c-weight of the invention.

FIG. 11 is a side perspective view of a fifth embodiment of sliding c-weight of the invention.

FIG. 12 is a cross-sectional side view of a sixth embodiment of sliding c-weight of the invention.

FIG. 13 is a front end view of the sixth embodiment of the c-weight of the present embodiment of the invention.

The same reference numerals refer to the same parts throughout the various figures.

### DETAILED DESCRIPTION OF THE INVENTION

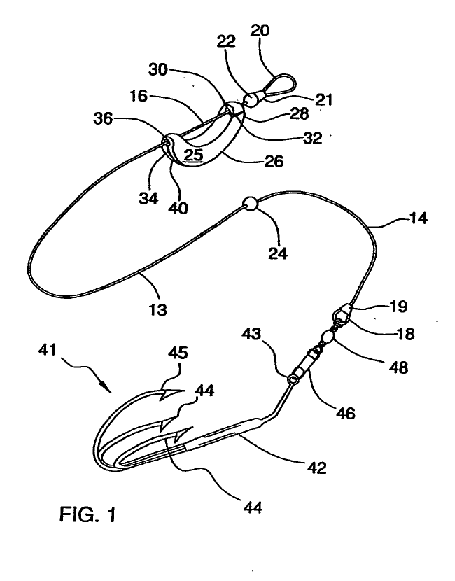

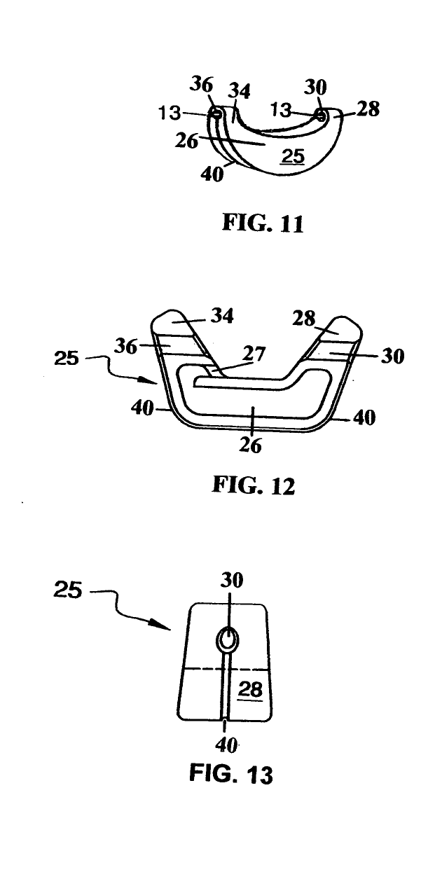

Referring now to the drawings, and particularly to FIGS. 1-10 which pertain to the removable sliding c-weight, FIGS. 11-13 are sliding c-weights without slots. A preferred embodiment of the sliding c-weight of the present invention is shown and generally designated by the reference numeral 25.

In the parent patent, FIG. 1 has a new and improved removable sliding c-weight 25 attached to a bottom fish rig 12. FIGS. 1 to 4 describe a removable sliding c-weight 25 of the bottom fish rig 12 which could also be utilized independently without a rig.

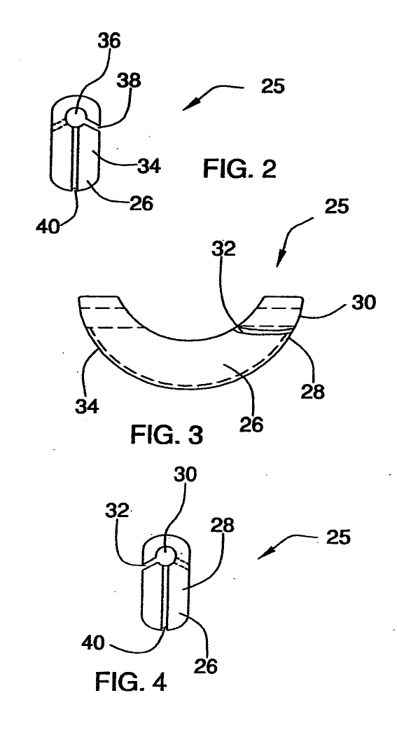

In FIG. 1 a removable sliding c-weight 25 is attached to the leader 13 and is enable to slide freely two-thirds of the length of the leader 13 to the movement stop 24. The c-weight 25 has three main sections, a first end 28, a c-weight hull 26, and a second end 34. The c-weight 25 has a first end 28 with a first bore there through 30. The c-weight 25 has a c-weight hull 26 in the central and lower middle section with a longitudinal groove 40. A longitudinal groove 40 extending across the outside of the bottom of the hull 26 and it is a shallow central semi-cylinder groove that connects with the first end 28 and the second end 34. The c-weight 25 has second end 34 with a second bore there through 36. The c-weight 25 has a first slot 32 connected to a first bore 30. The c-weight 25 has a second slot 38 as shown in FIG. 2 connected to a second bore 36. The c-weight 25 has a longitudinal groove 40 therein for allowing the c-weight to be fixedly connected to the leader 13.

In FIG. 2, the second end 34 of the sliding c-weight 25 is illustrated and will be described as by looking from the front but starting from the rear. The leader 13 slides, within the removable sliding c-weight 25 as shown in FIG. 1, by passing the leader 13 through the second slot 38 and wiggling it into the second bore 36. The second end 34 has the second bore there through 36. The c-weight 25 has the second slot 38 with a space to the second bore 36. The c-weight 25 has substantially the c-shape when the second end 34 is held upright and the c-weight 25 is viewed from the left side as in FIG. 3. As an option, the c-weight 25 has a longitudinal groove 40 in its mid-center therein for allowing the c-weight to be fixedly connected to the leader 13 by inserting the leader 13 into the groove 40 and running the leader through the first end 28 across the mid-center bottom of the hull 26 and through the second end 34.

In FIG. 3, the sliding c-weight 25 is illustrated and will be described from the left side view. The removable sliding c-weight 25 is connected to the leader 13 as shown in FIG. 1. The c-weight 25 has substantially the c-shape by viewing the left side with the second end 34 on top, the hull 26 vertically and the first end 28 on the bottom. The c-weight 25 has the first end 28. The c-weight 25 has a space from the first slot 32 to the first bore 30 as shown in FIG. 4. The leader 13 enters the c-weight 25 by sliding it horizontally into the first end slot 32, and subsequently is moved into the first bore 30 which is behind the first end slot 32. The leader 12 is also removed by sliding it from the first bore 36 into the slot 38 and away from the c-weight 25. The second end 34 has a second end slot 38 and second end bore 36 as shown in FIG. 2, but since it is on the opposite side of the c-weight 25 they can not be viewed from this left side view.

In FIG. 4, the first end 28 of the sliding c-weight 25 is illustrated and will be described as by looking from the front. The leader 13 slides within the c-weight 25 as shown in FIG. 1 by passing the leader 13 through the first slot 32 and wiggling it into the first bore 30. The first end 28 has the first bore there through 30. The c-weight 25 has a space from the first slot 32 to the first bore 30. The c-weight 25 has substantially the c-shape when the second end 34 is held upright, the first end 26 is toward the bottom and the c-weight 25 is viewed from the left side as in FIG. 3. As an option, the c-weight 25 has a longitudinal groove 40 in its mid-center therein for allowing the c-weight to be fixedly connected to the leader 13 by inserting the leader 13 into the groove 40 and running the leader through the first end 28 across the mid-center bottom of the hull 26 and through the second end 34.

FIG. 1 through FIG. 4 are illustrations of a preferred embodiment of a removable sliding c-weight 25 of a bottom fish rig 12. A nonobvious factor in the preferred embodiment is the c-weight first end 28 has a rising inclined first slot 32 connecting the first bore 30 on the left side. The second end 38 has a rising inclined second slot 38 connecting the second bore 36 on the right side. The inclined shape of the gap in the slot hinders the c-weight 12 from working its way off of the leader 13.

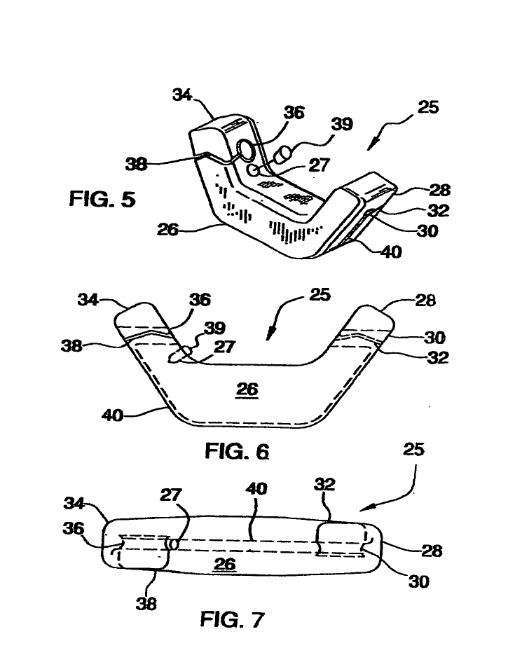

FIG. 5 through FIG. 8 are illustrations of a second preferred embodiment of a removable sliding c-weight 25. New features in the second embodiment of a removable sliding c-weight 25 are affiliated with a hollow c-weight hull 26 having a c-weight hull hole 27 and a c-weight hull hole plug 39. In the second embodiment small objects and different substances could be inserted into the c-weight hull hole 27 such as sand, clay, pebbles, stones, glass, ceramics, brick, silicone, bismuth, plastic, cement, epoxy, glue and pieces of metal, including lead pellets and lead substitutes such as different alloys of iron, steel, aluminum, tin, brass, bronze, zinc, nickel, and recyclable by products, and the like. Another use for a c-weight hull hole 27 could consist of inserting dense material with specific gravity heavier than water with different fluids including water with dissolved products, pheromones, scents, flavors, blood, egg, grounded fish parts, poultry, beef liver, insect parts, fish attractants, fruit, sugar, jelly, cheese, bread, food products, and the like. The c-weight hull could be made of various volumes and of many substances including lead, lead with a skin from electroplating, spraying, dipping, lead with a coating of zinc orthophosphate, paint, latex, vinyl, nylon, wax, gum, rubber, rubber composite, fiberglass polymer, harden tar, with or without a sealer, polymer based composite material, and also a mixture thereof. The c-weight hull could be made of various volumes and of many substances including different alloys of iron, steel, zinc, aluminum, tin, brass, bronze, ferrotungsten, and combinations thereof, and recyclable mixtures, plastic, synthetic containers, compressed wood, waxed products, epoxy, glue, rubber, frozen fluids, and the like. As an option, small holes could be drilled into the removable sliding c-weight hull 27 by the fisherman to attract fish.

Another difference in the second embodiment in FIG. 5 through FIG. 8 the c-weight first end 28 has the first slot on the right side; and an a-frame-shaped inclined second slot 38 on the second end on the left side. The shape of a first slot 32 and a second slot 38, with the different inclines hinder the c-weight 12 from working its way off of the leader 13. The slots 32 and 38 could be formed into other geometric shapes to make small obstacles to prevent the leader for accidentally working its way out of the first bore 30 and the second bore 36.

In FIG. 5 a second embodiment of the removable sliding c-weight of a bottom fish rig is illustrated and will be described from a top left perspective view. The removable sliding c-weight 25 has substantially the c-shape with three main sections, a first end 28, a c-weight hull 26, and a second end 34 with a new feature a c-weight hull hole 27. The c-weight 25 has a first end 28 with a first bore 30 that has a space to the first slot 32 on the right side. The c-weight 25 has a longitudinal groove 40 running down the outer mid-center of the first end 28 to the bottom, and extending beneath the outer c-weight hull 26 to the second end 34. The c-weight second end 34 has a second bore 36 that is connected to a second slot 38 on the left side. Beneath the second bore 36 at the inner mid-center junction and top of the c-weight hull 26 going toward the first end is a c-weight hole 27. In this embodiment the c-weight hull 26 is hollow and the c-weight hull plug 39 is used to keep substances for entering or leaving the hollow hull 26. A leader 13 is attached on the right side by moving it horizontally through the first slot 32 into the first bore 30 over the top of the second end 34 down the left side to the second slot 38 and slid into the second bore 36 for a freely sliding c-weight. A fixed c-weight would have the leader inserted into the longitudinal groove 40 first then through the first slot 32 and into the first bore 30 and subsequently to the second slot 38 and into the second bore 36.

In FIG. 6 a second embodiment of the removable sliding c-weight 25 of a bottom fish rig 12 is illustrated and will be described from the left side view. The second end 34 has a second slot 38 that penetrates to the second bore 36. Beneath the second bore 36 and toward the inner top of the c-weight hull 26 is the c-weight hull hole 27. The hollow c-weight hull 26 has a c-weight hole 27 with a c-weight hull plug 39 that could be removed and reinserted. Different substances could be inserted into the c-weight hole 27 to affect the action of the weight 25.

In FIG. 7 a second embodiment of the removable sliding c-weight 25 is illustrated and will be described from the top view. The c-weight first end 28 has a first slot 32 on the right side that connects to the first bore 30. The longitudinal groove 40 runs across the mid-center bottom of the c-weight hull 26. The c-weight second end 34 has a second slot 38 on the right side that is connected to the second bore 36. Beneath the second bore 36 and toward the inner top of the c-weight hull is the c-weight hull hole 27.

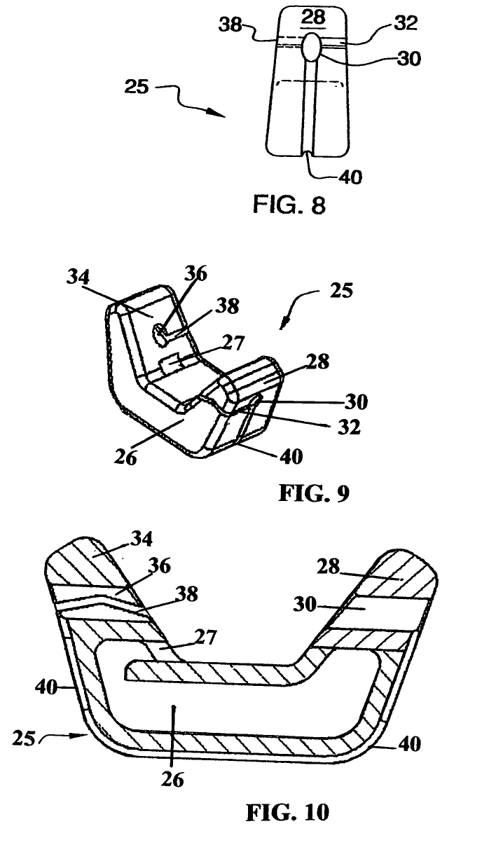

In FIG. 8 a second embodiment of the removable sliding c-weight 25 is illustrated and will be described from the front view. The c-weight first end 28 has a c-weight first bore 30 connected to a c-weight first slot 32 on the right side. The inclined a-framed slopes of the two slots are indicated by thicker lines at the c-weight first slot 32 and at the hidden c-weight second slot 38. The shallow central semi-cylinder groove longitudinal groove 40 descends from the first bore 30 down to the bottom of the c-weight hull 26.

In FIG. 9 a third embodiment of the removable sliding c-weight 25 is illustrated and described from an angled view. The slots are crafted on the opposite sides as the previous embodiments. The c-weight hole 27 is rectangular and does not have a plug. Objects and substances in the hull will be kept inside or released by natural physical forces.

In FIG. 10 a fourth embodiment of the removable sliding c-weight 25 is illustrated and described from a cross-section view. The c-weight hole 27 is rectangular and the overhang on the top of the c-weight hull 26 extends longer within the base of the c-weight hole 27. Objects and substances in the hull 26 will be kept inside or released by natural physical forces. The two ends 28 and 34 are angled to cause the weight to slide while being reeled to the fishing rod.

The sliding c-weight 25 in FIGS. 11 to 13 are made without slots and are not easily removed as the previous embodiments; however they are constructed to be made cheaper and quicker. The sliding c-weight 25 in FIGS. 11 to 13 will work effectively with commercial rigs. In FIG. 11 a fifth embodiment of the removable sliding c-weight 25 is illustrated and described from a side view. In FIG. 11 the fishing line or leader 13 is threaded into the bore 30 and 36, and the sliding c-weight has an arched hull 26 to allow the weight to roll on the bottom of waterways. The sliding c-weight 25 in FIG. 11 is not hollow and it has a groove to make it stay stationary upon a fishing line.

The sliding c-weight 25 in FIGS. 12 and 13 are made without slots and are not easily removed as the previous embodiments. In FIG. 12 a sixth embodiment of the removable sliding c-weight 25 is illustrated and described from a cross-section view. The c-weight hole 27 is rectangular and the top of the c-weight hull 26 extends longer within the base of the c-weight hole 27. Objects and substances in the hull 26 will be kept inside or released by natural physical forces. The two ends 28 and 34 are angled to cause the sliding c-weight 25 to slide like a sled while being used.

In FIG. 13 a sixth embodiment of the removable sliding c-weight 25 is illustrated and will be described from the front view. The c-weight first end 28 has a c-weight first bore 30 that does not have a slot 32 on any side as in the previous embodiments. The shallow central semi-cylinder groove longitudinal groove 40 descends from the first bore 30 down to the bottom of the c-weight hull 26 and to the other side as illustrated in FIG. 12.

The bottom fish rig, which is the parent patent, has a c-weight as a component of the invention. A c-weight is a fishing sinker shaped like a “C” and this patent has various embodiments. A c-weight in this patent has an embodiment that has two bores without slots in which a fishing line has to be inserted into each bore, and the removable sliding c-weight, that is attached and removed, without cutting the fishing line. The sliding c-weight could be used independently on a fishing line like a sinker or made as a component of a fishing rig. The sliding c-weight is unique by having two attributes that most other fishing sinkers do not possess, it slides freely or it could be fixed at a specific location on the fishing line. The “C” shaped sinker and the bores on both ends causes the weight to slide freely down a fishing line, or with a wrap of the fishing line or leader around its central hull, to become a stationary fishing sinker that is more versatile and easier to use that other fishing weights. One embodiment is a solid weight made of various metals or alloys, including but not limited to iron, tin, zinc, or silicone compounds. Another embodiment has a hollow hull that materials could be inserted to give the c-weight special effects and hollow hulls could be made with a means of creating a plurality of openings with perforations. Both embodiments, solid or with a hollow hull, could be made as a sliding c-weight or a removable sliding c-weight.

A removable sliding c-weight in this invention is installed without any tool, and is removed from the fishing line quicker than the common fishing tackle sinkers without cutting the fishing line or the leader to which it is attached. A removable sliding c-weight is installed by passing the line through a space in a first slot and into a first bore, then on the opposite side by passing a leader through a second slot and into a second bore. In another embodiment a removable sliding c-weight would also be made stationary by passing a leader through a first slot and into a first bore, then by running a leader in a longitudinal groove from a first end to a second end, and thirdly on the opposite side passing the leader through a second slot and into a second bore. A c-weight could also be made stationary by wrapping fishing line once or twice around its central hull. Another feature that is novel and useful in another embodiment of a removable sliding c-weight is to store fish attractant or inject other sinkable substances into a hollow hull through a hull hole and sealing it with a plug. Notably, any person of ordinary skill in the pertinent art, science or area of the sport of fishing could make and use the invention without extensive experimentation and catch a fish.

While embodiments in the drawings of the sliding c-weight have been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present embodiment of the invention. For example, in the bottom fish rig the longer leaders could be made of wire, but the smaller ones could be made of a strong monofilament fishing line which would carry a smaller sliding c-weight. Also any suitable sturdy material such iron, steel, glass with plastic coating, may be used instead of the lead for the c-weight described. Removable sliding c-weights range from fractions of an ounce to several ounces and others have a range of various volumes. An alternative to the preferred embodiment a bottom fish rig could have a c-weight without slots on either side and not be removable.

Therefore, the foregoing is considered as illustrative only of the principles of the embodiment of the invention. Further, since numerous modifications and changes will readily occur to those skilled in the art, it is not desired to limit the embodiment of the invention to the exact construction and operation shown and described, and accordingly, all suitable modifications and equivalents may be resorted to, falling within the scope of the embodiment of the invention.

What I claim as new is as follows:

1. A sliding c-weight for fishing comprising:
a c-weight having a substantially c-shape made of three main parts, a first end that has a first bore therethrough, a c-weight hull in the central and lower middle section that connects with a first end and a second end, and a second end that has a second bore therethrough as a means to attach to a fishing line.

2. A sliding c-weight of claim 1 wherein:
a c-weight hull in the central and lower middle section is composed of a solid materials or metal.

3. The sliding c-weight of claim 1 wherein:
a c-weight hull in the central and lower middle section is hollow and a means for inserting material within a hollow c-weight hull.

4. A removable sliding c-weight comprising:
a c-weight that could be removed and reinserted without cutting a leader, said c-weight having a substantially c-shape that could slide along a leader, said c-weight having a first end, said first end having a first bore therethrough, said c-weight having a second end, said second end having a second bore therethrough, said c-weight having a space from a first slot to said first bore on one side, and on the other side said c-weight having a second slot to said second bore, allowing the c-weight to be fixedly connected to a leader.

5. The sliding c-weight of claim 4 wherein:
said c-weight having a central longitudinal groove connecting said first bore, said c-weight hull and said second bore; and
said c-weight having a central longitudinal groove therein for allowing the c-weight to be fixedly connected to said leader.

6. The sliding c-weight of claim 4 wherein:
said c-weight having central bores in said first end and said second end to allow the leader to slide freely; and
the first slot and the second slot being inclined to hinder the leader from working its way out of the c-weight.

7. A sliding c-weight comprising:
a c-weight that could be removed and reinserted without cutting said leader, said c-weight having a substantially c-shape that could slide along the leader for two-thirds of said leader, said c-weight having a first end, said first end having a first bore therethrough, said c-weight having a second end, said second end having a second bore therethrough, said c-weight having a space from a first slot to said first bore on one side, on the opposite side said c-weight having a second slot to said second bore, and a hollow hull is between the first and second ends.

8. The sliding c-weight of claim 7 wherein:
beneath the second bore is a hollow c-weight hull hole and a hull hole plug; and
the hull hole plug stops material from entering and leaving a hollow c-weight hull.

9. The sliding c-weight of claim 7 wherein:
beneath a second bore is a hollow c-weight hull hole and a means of inserting material into the c-weight hull hole; and
a means of forming a plurality of openings in a hollow c-weight hull.

10. The sliding c-weight of claim 7 wherein:
beneath a second bore is a hollow c-weight hull hole that has a rectangular shape,
an overhang of a top of the c-weight hull extends longer within the base of a c-weight hole; and
objects and substances in the hull will be kept inside or released by natural physical forces.

11. The sliding c-weight of claim 7 wherein:
the central longitudinal groove is external; and
said hollow c-weight hull having an external central longitudinal groove therein for allowing the c-weight to be fixedly connected to said leader.

12. The sliding c-weight of claim 7 wherein:
a first slot and the second slot are inclined so as to hinder a leader from working its way out of the c-weight.

13. In combination, the sliding c-weight of claim 7 wherein:
the hollow c-weight is made of various volumes and of any substance including lead, lead with a skin from electroplating, spraying, dipping, lead with a coating of zinc orthophosphate, paint, latex, vinyl, nylon, wax, gum, rubber, rubber composite, fiberglass polymer, harden tar, with or without a sealer, polymer based composite material, and also a mixture thereof; and
said removable sliding c-weight having a hollow c-weight hull made of any non-lead substance including different alloys of iron, steel, zinc, aluminum, tin, brass, bronze, ferrotungsten, and combinations thereof, and recyclable mixtures, plastic, synthetic containers, compressed wood, waxed products, epoxy, glue, rubber, and frozen fluids.

14. In combination, the sliding c-weight of claim 3 wherein:
the hollow c-weight is made of various volumes and of any substance including lead, lead with a skin from electroplating, spraying, dipping, lead with a coating of zinc orthophosphate, paint, latex, vinyl, nylon, wax, gum, rubber, rubber composite, fiberglass polymer, harden tar, with or without a sealer, polymer based composite material, and also a mixture thereof; and
said removable sliding c-weight having a hollow c-weight hull made of any non-lead substance including different alloys of iron, steel, zinc, aluminum, tin, brass, bronze, ferrotungsten, and combinations thereof, and recyclable mixtures, plastic, synthetic containers, compressed wood, waxed products, epoxy, glue, rubber, and frozen fluids.
